(19) United States
(12) Patent Application Publication
(10) Pub. No.: US 2025/0045837 A1
(43) Pub. Date: Feb. 6, 2025

(54) ASSET MANAGEMENT DEVICE, ASSET MANAGEMENT METHOD, AND COMPUTER READABLE MEDIUM

(71) Applicant: Mitsubishi Electric Corporation, Tokyo (JP)

(72) Inventors: Suguru MATSUMOTO, Tokyo (JP); Atsushi HARADA, Tokyo (JP); Kazuhiro MAKI, Tokyo (JP); Shuto MURAI, Tokyo (JP)

(73) Assignee: Mitsubishi Electric Corporation, Tokyo (JP)

(21) Appl. No.: 18/923,443

(22) Filed: Oct. 22, 2024

Related U.S. Application Data
(63) Continuation of application No. PCT/JP2022/020753, filed on May 19, 2022.

(51) Int. Cl. G06Q 40/06; G06Q 10/0637

(52) U.S. Cl. CPC G06Q 40/06; G06Q 10/0637

(57) ABSTRACT

An asset value calculation unit (25) calculates an asset value with respect to an asset being an evaluation target based on an evaluation axis in a target business process to evaluate the asset value while using each of a plurality of business processes as a target. A contribution degree calculation unit (26) calculates an asset contribution degree indicating a degree that the asset being the evaluation target contributes to an organization objective by synthesizing the asset value calculated with respect to one or more business processes to realize a business strategy set to achieve the organization objective.

### CROSS REFERENCE TO RELATED APPLICATION

This application is a Continuation of PCT International Application No. PCT/JP2022/020753, filed on May 19, 2022, which is hereby expressly incorporated by reference into the present application.

### TECHNICAL FIELD

The present disclosure relates to a technique to support maintenance and management of assets possessed by an organization such as a company and the like.

### BACKGROUND ART

An organization possesses assets such as equipment, facilities and the like. In managing assets, it is necessary to consider execution of strategic operations such as inspection, maintenance and update while suppressing necessary cost and human resources. Therefore, in recent years, there has been an increasing number of cases in which asset management methods are applied to the maintenance and management strategy of assets. Assets include various properties such as human resources, data, software and real estates as well as equipment and facilities.

In each company, operational status data of assets, and inspection and diagnostic data of assets are accumulated. Further, an attempt to incorporate the concept of asset management method into the asset maintenance and management strategy has been made based on the data accumulated.

Patent Literature 1 discloses that a list of measures that should be implemented and optimum implementation plans of measures are presented based on data accumulated regarding assets, and an asset preservation item expected to be improved by a user.

### CITATION LIST

### Patent Literature

Patent Literature 1: JP2020-181230 A

### SUMMARY OF INVENTION

### Technical Problem

According to the technique disclosed in Patent Literature 1, a preservation measure deemed to be most suited in a range of preservation operations of assets is presented. However, in the technique disclosed in Patent Literature 1, the value of the assets themselves are not managed. Therefore, it is impossible to specifically indicate which asset should be invested among the assets possessed by the company on a priority basis.

In order to indicate the value of assets, it is necessary to comprehensively calculate the value of assets from contribution to various objectives of the organization related to the assets, such as increase in profit, improvement in employee satisfaction and the like. The technique disclosed in Patent Literature 1 examines only the point of view of preservation operations of assets, and is incapable of calculating the essential value of the assets.

The present disclosure is aimed at supporting examination on which asset the organization should perform investment on a priority basis.

### Solution to Problem

An asset management device according to the present disclosure includes
an asset value calculation unit to calculate an asset value with respect to an asset being an evaluation target based on an evaluation axis in a target business process, the evaluation axis being for evaluating the asset value, while using each of a plurality of business processes as a target, and
a contribution degree calculation unit to calculate an asset contribution degree indicating a degree that the asset being the evaluation target contributes to an organization objective by synthesizing the asset value calculated by the asset value calculation unit with respect to one or more business processes to realize a business strategy which is set to achieve the organization objective.

### Advantageous Effects of Invention

In the present disclosure, a contribution degree of an asset to an objective of an organization is calculated. By indicating the contribution degree of the asset, it is possible to support examination on which asset the organization should perform investment on a priority basis.

### BRIEF DESCRIPTION OF DRAWINGS

FIG. 1 is a diagram of a hardware configuration of an asset management device 10 according to a first embodiment;

FIG. 2 is a diagram of a functional configuration of the asset management device 10 according to the first embodiment;

FIG. 3 is an explanatory drawing of relation information stored in a relation information storage unit 33 according to the first embodiment;

FIG. 4 is a flowchart illustrating an overall process of the asset management device 10 according to the first embodiment;

FIG. 5 is a flowchart illustrating a setting acceptance process according to the first embodiment;

FIG. 6 is a diagram illustrating a concrete example of the relation information according to the first embodiment;

FIG. 7 is a flowchart illustrating a calculation process according to the first embodiment;

FIG. 8 is a diagram illustrating a display example of a visualization process according to the first embodiment;

FIG. 9 is a diagram illustrating a display example of the visualization process according to the first embodiment; and

FIG. 10 is a diagram illustrating a display example of the visualization process according to the first embodiment.

### DESCRIPTION OF EMBODIMENTS

### First Embodiment

### Description of Configuration

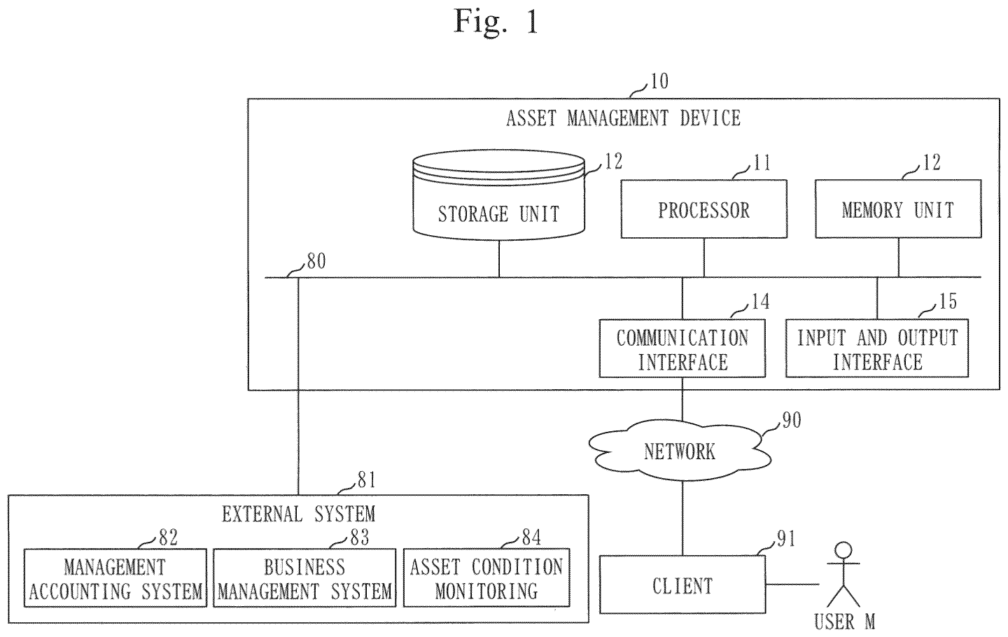

Description will be made on a hardware configuration of an asset management device 10 according to a first embodiment with reference to FIG. 1.

The asset management device 10 is a computer.

The asset management device 10 includes hardware components of a processor 11, a memory unit 12, a storage unit 13, a communication interface 14, and an input and output interface 15. The processor 11 is connected to the other hardware components via a signal line 80, and controls these other hardware components.

The processor 11 is an IC to perform processing. IC is an abbreviation for Integrated Circuit. The processor 11 is, for example, a CPU, a DSP or a GPU. CPU is an abbreviation for Central Processing Unit. DSP is an abbreviation for Digital Signal Processor. GPU is an abbreviation for Graphics Processing Unit.

The memory unit 12 is a storage device to temporarily store data. The memory unit 12 is, for example, an SRAM or a DRAM. SRAM is an abbreviation for Static Random Access Memory. DRAM is an abbreviation for Dynamic Random Access Memory.

The storage unit 13 is a storage device to store data. The storage unit 13 is, for example, an HDD. HDD is an abbreviation for Hard Disk Drive. Further, the storage unit 13 may be a portable recording medium such as an SD (registered trademark) memory card, a CompactFlash (registered trademark), a NAND Flash memory, a flexible disk, an optical disk, a compact disk, a Blue-ray (registered trademark) disk, a DVD or the like. SD is an abbreviation for Secure Digital. DVD is an abbreviation for Digital Versatile Disk.

The communication interface 14 is an interface to communicate with an external device. The communication interface 14 is, for example, a port of an Ethernet (registered trademark).

The asset management device 10 is connected to a network 90 via the communication interface 14. A client terminal 91 is connected to the network 90. The network 90 is, for example, the Internet or a LAN. LAN is an abbreviation for Local Area Network. The client terminal 91 is, for example, a PC. PC is an abbreviation for Personal Computer. The client terminal 91 provides a user M with an HMI. HMI is an abbreviation for Human Machine Interface. As the user M, various interested persons of a corporate organization are expected.

The input and output interface 15 is an interface to which an input and output device is connected. The input and output interface 15 is, for example, a USB port or an HDMI (registered trademark) port. USB is an abbreviation for Universal Serial Bus. HDMI is an abbreviation for High-Definition Multimedia Interface.

In the asset management device 10, an external system 81 is connected to the signal line 80. In this manner, the asset management device 10 is capable of making functions cooperate with another systems in the organization. The external system 81 is a system of a management accounting system 82, a business management system 83 and an asset condition monitoring system 84. The management accounting system 82 manages accounting data of the organization. The business management system 83 manages business administration data of the organization. The asset condition monitoring system 84 monitors the condition of the assets possessed by the organization.

The asset management device 10 may be connected with the external system 81 via the communication interface 14 and the network 90.

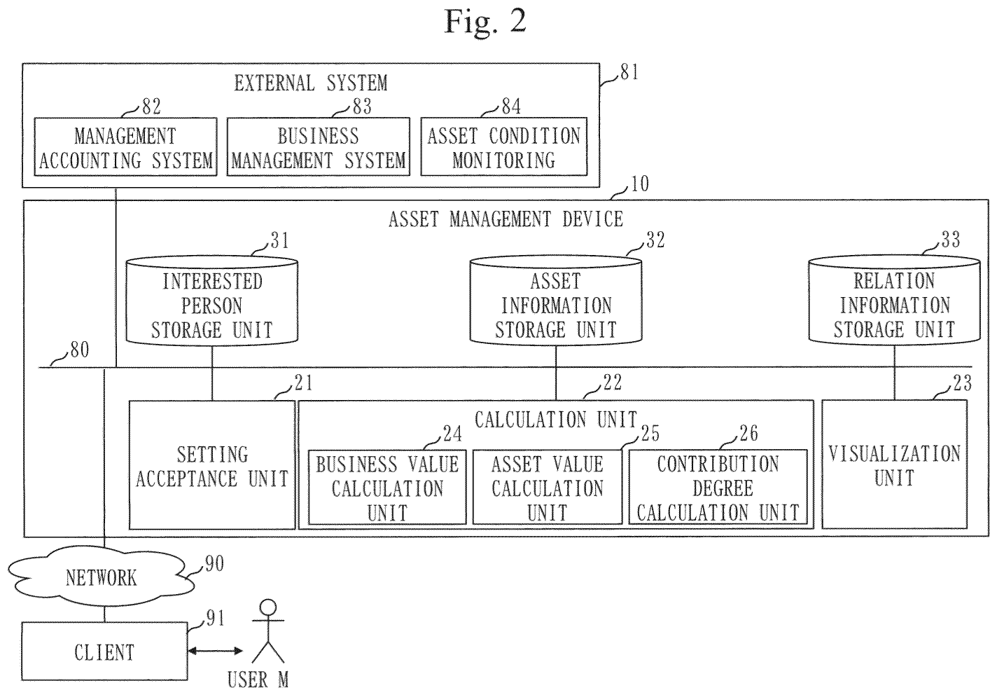

Description will be made on a functional configuration of the asset management device 10 according to First Embodiment with reference to FIG. 2.

The asset management device 10 is equipped with a setting acceptance unit 21, a calculation unit 22 and a visualization unit 23 as functional components. The calculation unit 22 is equipped with a business value calculation unit 24, an asset value calculation unit 25 and a contribution degree calculation unit 26. The functions of each functional component of the asset management device 10 is realized by software.

In the storage unit 13, programs to realize the functions of each functional component of the asset management device 10 are stored. These programs are read into the memory unit 12 by the processor 11, and executed by the processor 11. In this manner, the functions of each functional component of the asset management device 10 are realized.

The asset management device 10 is equipped with storage units of an interested person storage unit 31, an asset information storage unit 32 and a relation information storage unit 33. Each storage unit is realized by the storage unit 13. Each storage unit may be realized by an external storage device of the asset management device 10.

In the interested person storage unit 31, information on interested persons to identify various interested persons of the corporation is stored. In the asset information storage unit 32, asset information of the assets possessed by the corporation is stored. The relation information storage unit 33 stores relation information representing relations between organization objectives and the assets in a hierarchical structure in which business strategies and business processes intervene.

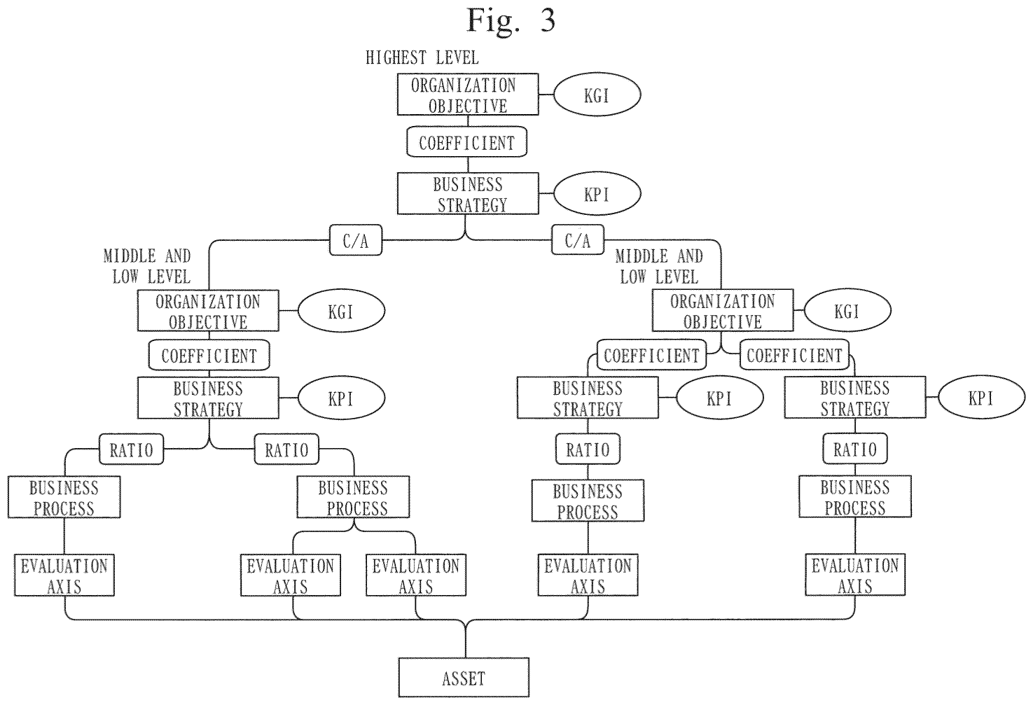

Description will be made on relation information stored in the relation information storage unit 33 according to First Embodiment with reference to FIG. 3.

The relation information represents relations among the organization objectives, the business strategies, the business processes and the assets in a hierarchical structure. The organization objectives are objectives aimed by an organization of a corporation and the like. The business strategies are strategies to achieve the organization objectives. The business processes are concrete processes to realize the business strategies. The assets are properties used in the business processes.

The relation information includes indicators to calculate degrees of relations between each component in the hierarchical structure. The indicators are a KGI, a KPI, a coefficient, a ratio and an evaluation axis. KGI is an abbreviation for Key Goal Indicator. KPI is an abbreviation for Key Performance Indicator. KGI indicates an achievement goal of the organization objective. KPI indicates an achievement goal of the business strategy. The coefficient indicates a degree of relevance of the business strategy to the organization objective. The ratio indicates a degree of relevance of the business process to the business strategy. The evaluation axis indicates an evaluation viewpoint of the asset related to each business process.

Middle-level and low-level organization objectives can be set below the business strategy to achieve the primary organization objective. The relation between a business strategy in a high-level layer and an organization objective in a low-level layer is managed by an indicator of C/A. C/A is an abbreviation for Context Assumption. In this case, the KGI of the organization objective and the KPI of the business strategy in each layer are defined by the same indicator (unit).

### Description of Operation

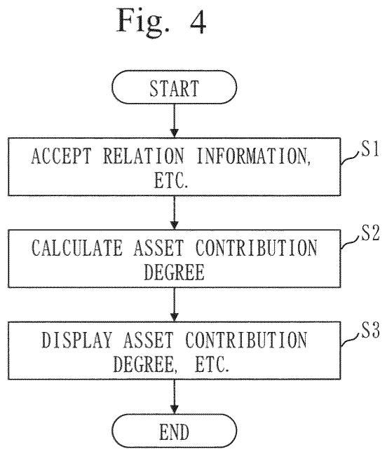

Description will be made on an operation of the asset management device 10 according to First Embodiment with reference to FIG. 4 through FIG. 10.

An operation procedure of the asset management device 10 according to First Embodiment corresponds to an asset management method according to First Embodiment. Further, a program to realize the operation of the asset management device 10 according to First Embodiment corresponds to an asset management program according to First Embodiment.

The description below assumes that the asset information storage unit 32 stores a variety of information of assets possessed by the organization beforehand. For example, in the asset information storage unit 32, an asset name, an intended use, manufacturer information, a purchase history, a maintenance and inspection history, a fatigue degree, a lifetime prediction value, an asset condition and the like are stored with respect to each asset. The information stored in the asset information storage unit 32 is input by the user M or from the external system 81 connected.

Description will be made on a flow of an entire process of the asset management device 10 according to First Embodiment with reference to FIG. 4.

### (Step S1: Setting Acceptance Process)

The setting acceptance unit 21 accepts input of relation information to be stored in the relation information storage unit 33.

Specifically, the setting acceptance unit 21 accepts information input in accordance with an operation by the user M being the interested person of the organization. The setting acceptance unit 21 writes the information accepted in the relation information storage unit 33.

When the relation information has already been set, the process of Step S1 can be skipped.

### (Step S2: Calculation Process)

The calculation unit 22 calculates an asset contribution degree of an asset being an evaluation target to the organization objective based on the information stored in the relation information storage unit 33.

### (Step S3: Visualization Process)

The visualization unit 23 displays the asset contribution degree, the information obtained in the calculation process of the asset contribution degree and the like, on the client terminal 91 or the like.

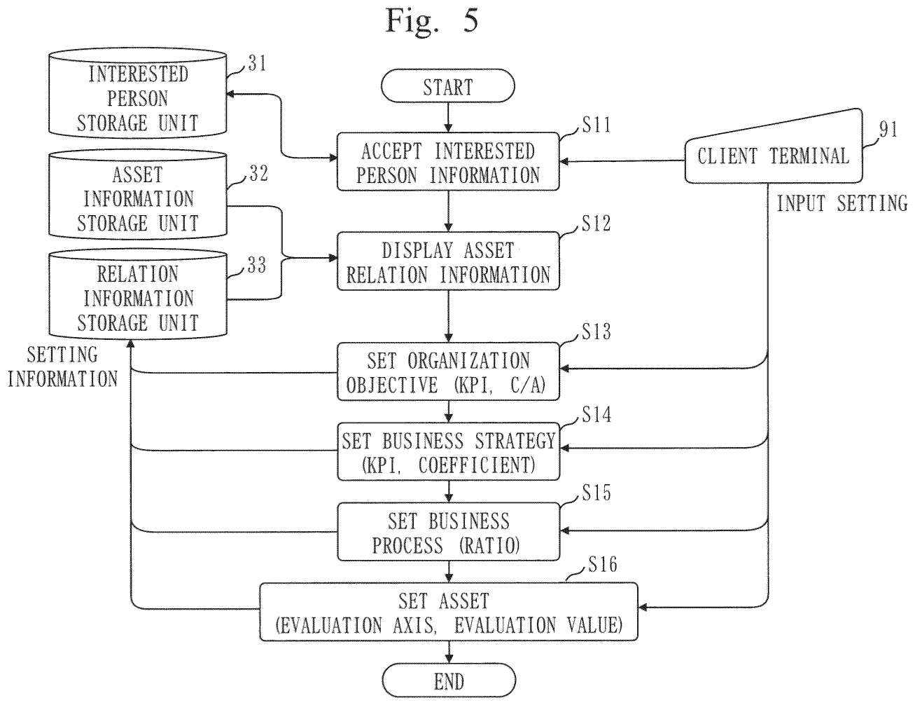

Description will be made on a setting acceptance process according to First Embodiment with reference to FIG. 5.

### (Step S11: Interested Person Information Acceptance Process)

The setting acceptance unit 21 accepts interested person information.

Specifically, the setting acceptance unit 21 accepts the interested person information input from the client terminal 91 and the like by the user M. The interested person information includes information to identify the user M such as a full name, a position and a job category. The setting acceptance unit 21 writes the interested person information in the interested person storage unit 31.

There is a case in which the interested person information of the user M has already been stored in the interested person storage unit 31. In this case, it may be possible to change the process so that the setting acceptance unit 21 reads out the interested person information from the interested person storage unit 31 after performing authentication using an ID, a password and the like.

### (Step S12: Information Display Process)

The setting acceptance unit 21 displays the asset information stored in the asset information storage unit 32 and the relation information that has been already stored in the relation information storage unit 33 on the client terminal 91 or the like.

In Step S13 through Step S16, the relation information is edited while the user M refers to the information displayed in Step S12. The range of the information that can be confirmed and set by the user M may be limited depending on the position, the job category or the like included in the interested person information input in Step S11. Each piece of data may be set not only by manual entry by the user M, but also by reading the data possessed by the asset management device 10 or the data possessed by the external system 81.

### (Step S13: Organization Objective Setting Process)

The setting acceptance unit 21 accepts setting regarding the organization objectives.

Specifically, the setting acceptance unit 21 accepts setting of a new organization objective, and change or deletion of an existing organization objective. Further, the setting acceptance unit 21 accepts setting related to the KGI or the C/A regarding the organization objective. The setting acceptance unit 21 writes the information accepted in the relation information storage unit 33.

### (Step S14: Business Strategy Setting Process)

The setting acceptance unit 21 accepts setting regarding the business strategy.

Specifically, the setting acceptance unit 21 accepts setting of a new business strategy, and change or deletion of an existing business strategy. Further, the setting acceptance unit 21 accepts setting related to the KPI or the coefficient regarding the business strategy. The setting acceptance unit 21 writes the information accepted in the relation information storage unit 33.

### (Step S15: Business Process Setting Process)

The setting acceptance unit 21 accepts setting regarding the business process.

Specifically, the setting acceptance unit 21 accepts setting of a new business process, and change or deletion of an existing business process. Further, the setting acceptance unit 21 accepts setting related to a ratio regarding the business process. The setting acceptance unit 21 writes the information accepted in the relation information storage unit 33.

### (Step S16: Asset Setting Process)

The setting acceptance unit 21 accepts setting regarding assets.

Specifically, the setting acceptance unit 21 accepts setting of a new asset, and change or deletion of an existing asset. Further, the setting acceptance unit 21 accepts setting related to an evaluation axis or an evaluation value regarding an asset. The setting acceptance unit 21 writes the information accepted in the relation information storage unit 33.

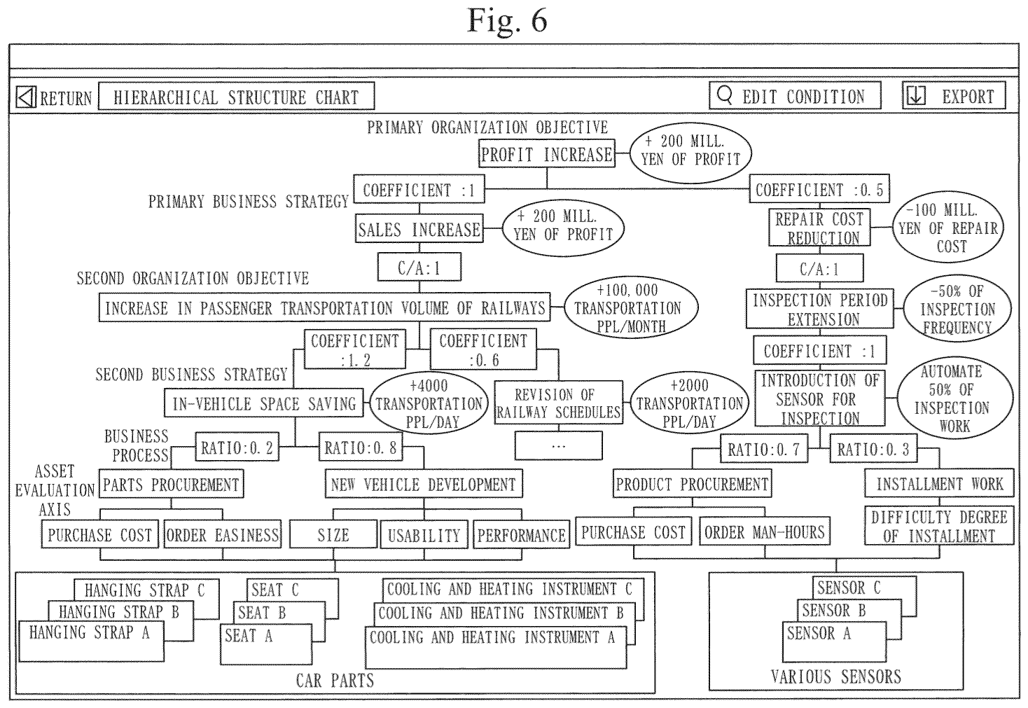

Description will be made on a concrete example of the relation information according to First Embodiment, with reference to FIG. 6.

The object to be applied the asset management device 10 is not limited to a specific project, organization or asset. Herein, description will be made by taking as an example a case in which the asset management device 10 is applied to an organization expanding a railway enterprise.

As for the business organization expanding the railway enterprise, the case as follows is assumed. As the organization structure, a director or an executive is placed at the top, and medium and small structures of divisions, departments, sections and the like are hierarchically placed thereunder depending on the responsibilities or roles. An interested person in the high level in the organization structure sets the primary organization objective of increase in profit, and an increase in sales and reduction in repair costs as business strategies to achieve the primary organization objective. An interested person in the middle level in the organization structure sets an organization objective of increase in the passenger transportation volume of railways under the increase in sales, and an organization objective of extension of inspection periods under reduction in repair costs. Further, the interested person in the middle level sets in-vehicle space saving and revision of railway schedules as the business strategies to achieve the increase in the passenger transportation volume of railways, and sets introduction of sensors for inspection as the business strategy to achieve the extension of inspection periods. The interested person in the low level in the organization structure sets business processes to implement the business strategies.

In Step S13 through Step S16, the user M edits each component of the organization objectives, the business strategies, the business processes, the assets and the like, and the relations between each component while referring to diagram of the hierarchical structure indicated by the relation information displayed in Step S12, and the like. For example, the organization objective or the content of assets is changed. Otherwise, addition of a new component or deletion of an unnecessary component is performed.

When a plurality of business strategies are set for an organization objective, values of coefficients are input between the organization objective and the business strategies. In this manner, weights of the business strategies relative to the organization objective are set. Further, when a plurality of low-level organization objectives are set under a business strategy, values of C/As are input between the business strategy and the low-level organization objectives. In this manner, weights of the low-level organization objectives relative to the business strategy are set. When a plurality of business processes are set for a business strategy, values of ratio are input between the business strategy and the business processes. In this manner, weights of the business processes relative to the business strategy are set.

Herein, the coefficient is set by a proportion (KPI/KGI) obtained by dividing KPI by KGI. C/As are set so that the sum of weights of the organization objectives set under the business strategy shall be 1. The ratios are set so that the sum of weights of the business processes set for one business strategy shall be 1.

A plurality of assets related to a business process are set under the business process. When the assets are set under the business process, the evaluation axis for each asset is set by an interested person related to each business process. As the evaluation axis, it is possible to set not only an indicator which can be evaluated quantitatively, but also an indicator which requires qualitative evaluation. The indicator which can be evaluated quantitatively is, for example, size or performance. The indicator which requires qualitative evaluation is, for example, usability.

An evaluation value is set for each evaluation axis. For the evaluation axis which can be quantitatively evaluated, the evaluation value is obtained and set from data stored in the asset information storage unit 32, data stored in the external system 81, or the like. For the evaluation axis which requires qualitative evaluation, the evaluation value is input and set by an interested person to use the asset being the evaluation target in each business process.

In FIG. 6, coefficients, C/As, ratios and evaluation axes are set as follows.
(1) Organization objective: increase in profit, KGI (desired value): net profit (+two hundred million [yen]).
(2) Business strategy to achieve the organization objective of (1): increase in sales, KPI (desired value): sales (+two hundred million [yen]), coefficient=KPI/KGI=two hundred million [yen]/two hundred million [yen]=1.
(3) Organization objective of low-level organization to achieve the business strategy of (2): increase in the passenger transportation volume of railways, KGI (desired value): transportation number of people (+100 thousand [people/month]), C/A=1. Since there is only one organization objective linked to the business strategy of (2), C/A shall be 1.
(4) Business strategy to achieve the organization objective of (3): in-vehicle space saving, KPI (desired value): transportation number of people (+four thousand [people/day]), coefficient=KPI/KGI=approximately 120 thousand [people/month]/100 thousand [people/month]≈1.2. 120 thousand [people/month] is a value obtained by multiplying+four thousand [people/day] by thirty days.
(5) Business strategy to achieve the organization objective of (3): revision of railway schedules, KPI (desired value): transportation number of people (+two thousand [people/day]), coefficient=KPI/KGI=sixty thousand [people/month]/100 thousand [people/month]=0.6. Sixty thousand [people/month] is a value obtained by multiplying+two thousand [people/day] by thirty days.
(6) Business process to implement the business strategy of (4): parts procurement, ratio: 0.2. The ratio is arbitrarily input under the condition that the sum of this ratio and a ratio of the business process of (7) shall be 1.
(7) Business process to implement the business strategy of (4): development of a new vehicle, ratio: 0.8. The ratio is arbitrarily input under the condition that the sum of this ratio and the ratio of the business process of (6) shall be 1.
(8) Assets necessary to implement the business strategy of (4): hanging strap/seat/cooling and heating instrument, and the like.
(9) Evaluation axes when the assets of (8) are viewed from the perspective of the business process of (6): purchase cost and easiness to order.
(10) Evaluation axes when the assets of (8) are viewed from the perspective of the business process of (7): size, usability and performance.

Business strategy to achieve the organization objective of (1): reduction in repair costs, and the lower layers below this business strategy are set in accordance with the similar rule.

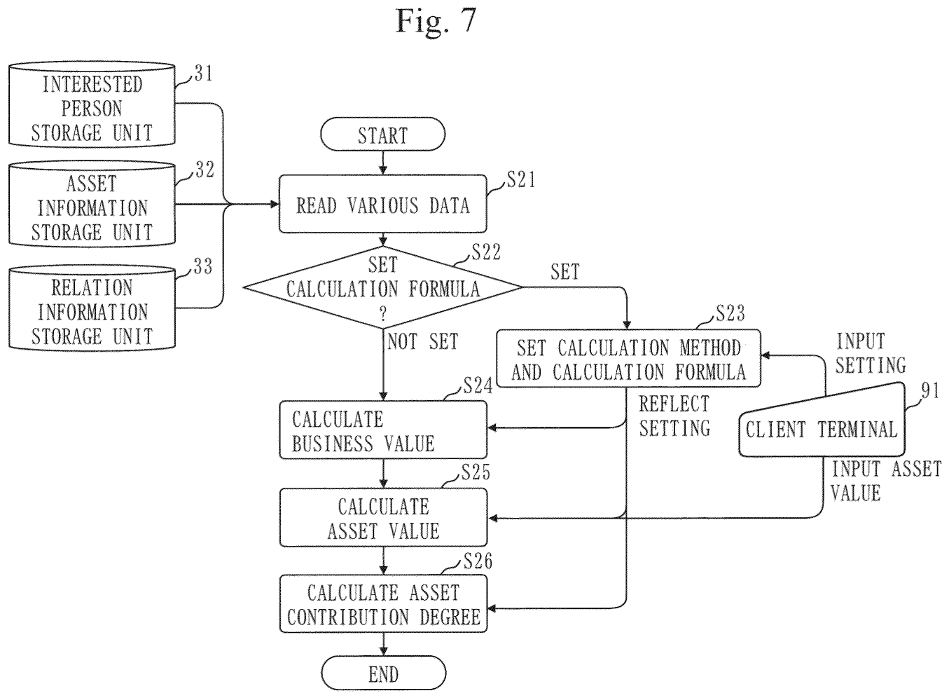

Description will be made on a calculation process according to First Embodiment with reference to FIG. 7.

### (Step S21: Information Reading Processing Process)

The calculation unit 22 reads the interested person information of the user M from the interested person storage unit 31. Further, the calculation unit 22 reads the information stored in the asset information storage unit 32 and the relation information storage unit 33.

### (Step S22: Change Decision Process)

The calculation unit 22 decides whether change of the calculation method of the asset contribution degree or the condition of the calculation formula is desired. When change is desired, the calculation unit 22 proceeds with the process to Step S23. Meanwhile, when change is not desired, the calculation unit 22 proceeds with the process to Step S24.

### (Step S23: Calculation Change Process)

The calculation unit 22 accepts change of the calculation method or the condition of the calculation formula.

The condition is, for example, to perform calculation of the asset contribution degree using only an evaluation value set by an interested person at a specific position, and the like.

### (Step S24: Business Evaluation Calculation Process)

The business value calculation unit 24 of the calculation unit 22 calculates a business value being a value of a target business strategy relative to the organization objective, by using each of one or more business strategies included in the relation information as the target. The value of the target business strategy relative to the organization objective can be restated as a contribution degree of the target business strategy to achievement of the organization objective.

Specifically, the business value calculation unit 24 sets each of one or more business strategies included in the relation information as the target business strategy. The business value calculation unit 24 calculates the business value of the target business strategy from the coefficient with respect to the target business strategy, and an achievement ratio of KPI of the target business strategy. The coefficient is a proportion of a desired value indicated in an achievement goal set for the target business strategy relative to the desired value indicated in the organization objective. The achievement ratio of KPI is a proportion of a realized value that is achieved with the target business strategy relative to the desired value indicated in the achievement goal (KPI) set for the target business strategy. Herein, the business value calculation unit 24 calculates the business value by multiplying the achievement ratio of KPI by the coefficient.

That is, the business value calculation unit 24 calculates the business value by Formula 1.

$$Business value [ \% ] = coefficient \times ( KPI ( realized value ) / KPI ( desired value ) ) \times 100 \qquad ( Formula 1 )$$

When there is an upper layer above the target business strategy, the business value calculation unit 24 calculates a business value regarding the target business strategy relative to an organization objective of the upper layer above the target business strategy. Herein, the target business strategy is assumed to be the in-vehicle space saving in FIG. 6. In this case, the organization objective in the same layer as the target business strategy is increase in the passenger transportation volume of railways. Further, the business strategy in the upper layer is increase in sales, and the organization objective in the upper layer is increase in profit.

Specifically, the business value calculation unit 24 calculates a value obtained by multiplying a business value of the target business strategy relative to the organization objective in the same layer as the target business strategy by C/A. The business value calculation unit 24 multiplies a business value of the business strategy in the upper layer relative to the organization objective in the upper layer by this value. In this manner, the business value of the target business strategy relative to the organization objective in the upper layer is calculated.

That is, the business value calculation unit 24 calculates the business value of the target business strategy relative to the organization objective in the upper layer by Formula 2.

$$Business value relative to the organization objective in the upper layer [ \% ] = business value relative to the organization objective in the same layer [ \% ] \times C / A \times business value of the business strategy in the upper layer relative to the organization objective in the upper layer [ \% ] \qquad ( Formula 2 )$$

### (Step S25: Asset Value Calculation Process)

The asset value calculation unit 25 of the calculation unit 22 calculates an asset value of an asset being an evaluation target.

Specifically, the asset value calculation unit 25 sets each of a plurality of business processes as a target business process. The asset value calculation unit 25 sets each of one or more assets set in the target business process as the asset being the evaluation target. The asset value calculation unit 25 calculates the asset value of the asset being the evaluation target based on an evaluation axis in the target business process, for evaluating the asset value. The asset value calculation unit 25 calculates, when a plurality of evaluation axes are set for the asset being the evaluation target, a mean value or a weighted average value of the asset values calculated from the evaluation values of each evaluation axis as the asset value of the asset being the evaluation target.

For example, it is assumed that the target business process is development of the new vehicle in FIG. 6. The asset being the evaluation target is assumed to be a hanging strap A. In this case, there are three evaluation axes of size, usability and performance. Herein, it is assumed that each evaluation axis is weighted, and that a weight for size is 0.5, a weight for usability is 0.3, and a weight for performance is 0.2. Additionally, it is assumed that the evaluation value of size is 80 points, the evaluation value of usability is 90 points, and the evaluation value of performance is 50 points. Then, the asset value of the hanging rope A shall be: 0.5×80+0.3× 90+0.2×50=77 points.

### (Step S26: Asset Contribution Degree Calculation Process)

The contribution degree calculation unit 26 of the calculation unit 22 calculates an asset contribution degree indicating a degree of contribution of the asset being the evaluation target to the organization objective.

Specifically, the contribution degree calculation unit 26 sets a target organization objective from the organization objectives in the lower layer in order. The contribution degree calculation unit 26 sets business strategies to achieve the target organization objective as the target business strategy in order. The contribution degree calculation unit 26 calculates an overall value synthesizing the asset values calculated in Step S26 with respect to one or more business processes to realize the target business strategy. Herein, when the organization objective in the lowest layer is the target organization objective, the contribution degree calculation unit 26 calculates the overall value by calculating values obtained by multiplying the asset values by the ratios with respect to each of one or more business processes, and by totaling the values calculated. The contribution degree calculation unit 26 calculates the asset contribution degree from the business value of the target business strategy to the target organization objective calculated in Step S24, and the overall value calculated. Herein, the contribution degree calculation unit 26 calculates the asset contribution degree by multiplying the overall value by the business value.

For example, it is assumed that the target organization objective is increase in the passenger transportation volume of railways in FIG. 6. The target business strategy is assumed to be in-vehicle space saving. The asset being the evaluation target is assumed to be the hanging strap A. The asset value of the hanging strap A in a case in which the business process is parts procurement is assumed to be 80 points. The asset value of the hanging strap A in a case in which the business process is development of a new vehicle is assumed to be 77 points. Then, the asset contribution degree of the hanging strap A to the increase in the passenger transportation volume of railways is: business value of in-vehicle space saving×overall value (0.2×80+0.8×77).

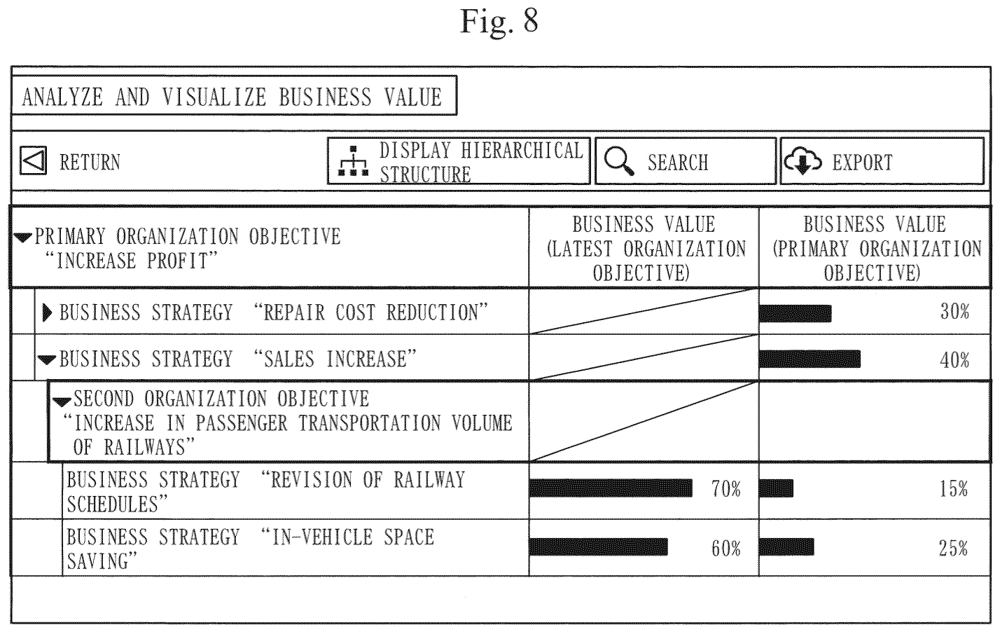

Description will be made on a visualization process according to First Embodiment with reference to FIG. 8 through FIG. 10.

The visualization unit 23 displays the asset contribution degrees, the information obtained in the calculation process of the asset contribution degrees and the like on the client terminal 91 or the like. The information obtained in the calculation process of the asset contribution degrees is, for example, a business value with respect to each business strategy, and an evaluation value with respect to each asset.

For example, the visualization unit 23 displays the business values of the business strategies relative to the organization objectives as illustrated in FIG. 8. In this manner, it is possible to recognize how much each business strategy contributes to achievement of each organization objective.

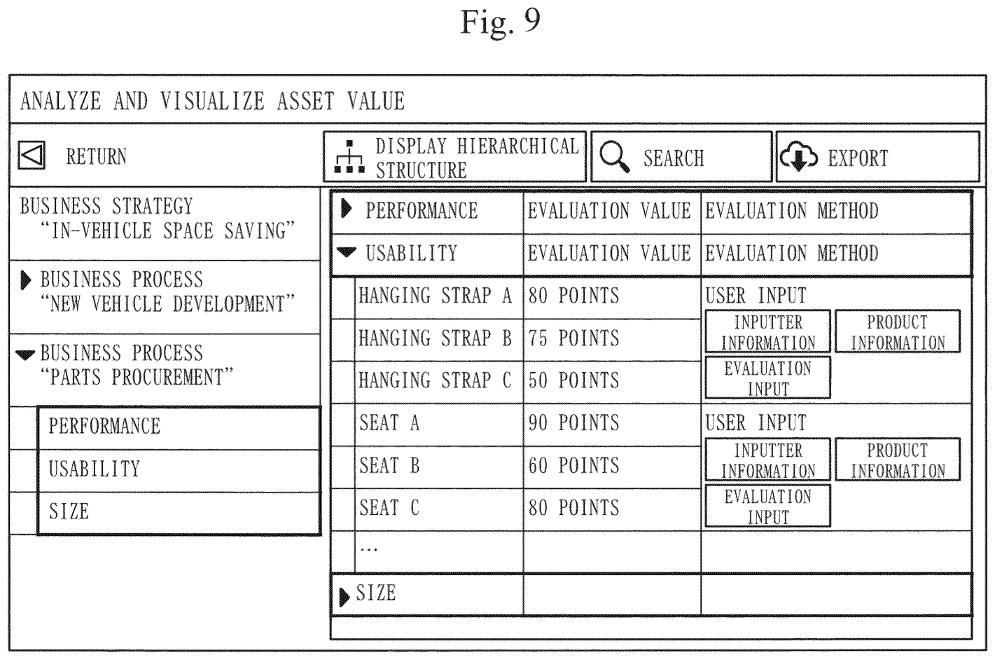

Further, the visualization unit 23 displays the evaluation axes and the evaluation values of the assets used in the business processes, as illustrated in FIG. 9. In this manner, it is possible to recognize the evaluation axes and the evaluation values used in the process of calculation of the asset contribution degrees.

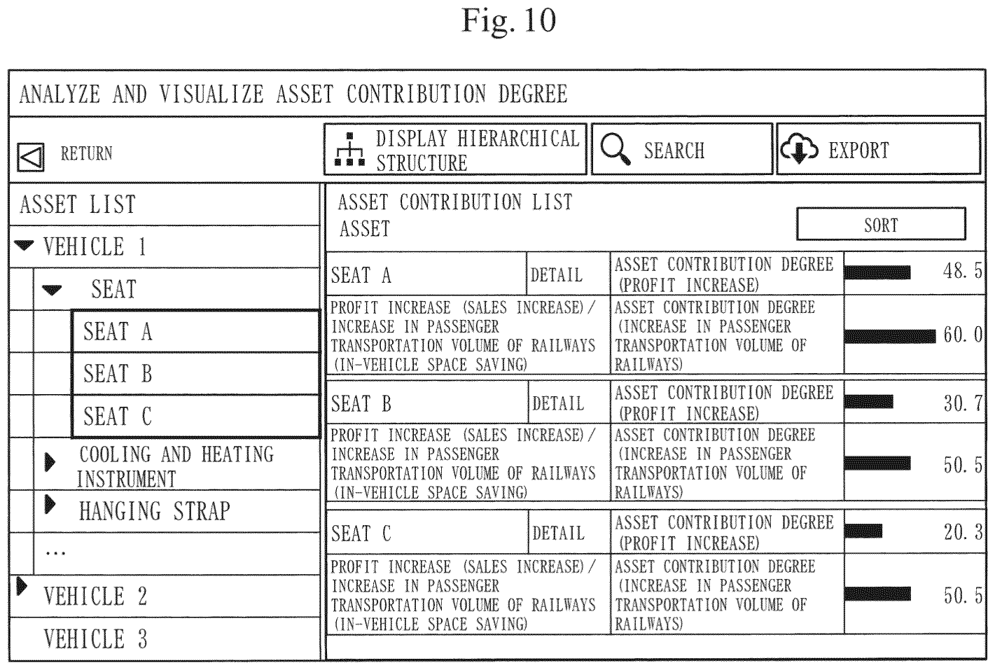

Further, the visualization unit 23 displays the asset contribution degrees of each asset to the organization objectives, as illustrated in FIG. 10. In this manner, it is possible to recognize how much each asset contributes to achievement of the organization objectives. In FIG. 10, the seat that contributes most to increase in profit, which is the primary organization objective, is “seat A” of which the asset contribution degree is highest.

### Effect of First Embodiment

As described above, the asset management device 10 according to First Embodiment calculates the asset contribution degrees to the organization objectives. By presenting the asset contribution degrees, it is possible to support consideration on which asset the organization should perform investment on a priority basis.

More specifically, the asset management device 10 according to First Embodiment manages relations between organization objectives and assets held by the organization. Then, the asset management device 10 calculates the asset contribution degrees representing essential values of the assets by evaluating how much the assets contribute to achievement of various organization objectives as well as the maintenance operation. In this manner, it is possible to support consideration on which asset the organization should perform investment on a priority basis.

Further, the asset management device 10 according to First Embodiment displays the information obtained in the calculation process of the asset contribution degrees as well as the asset contribution degrees. Specifically, the asset management device 10 displays the business values with respect to each business strategy, and the evaluation values with respect to each asset. In this manner, it is possible to support consideration on validity of each business strategy. Further, it is possible to support consideration on validity of calculation of the asset contribution degrees.

### Other Configurations

### First Variation

In First Embodiment, each functional component is realized by software. However, as First Variation, each functional component may be realized by a hardware component. As for this First Variation, parts different from First Embodiment will be described.

Description will be made on a configuration of the asset management device 10 according to First Variation.

When each functional component is realized by the hardware component, the asset management device 10 is equipped with an electronic circuit instead of the processor 11, the memory unit 12 and the storage unit 13. The electronic circuit is a dedicated circuit to realize each functional component, and the functions of the memory unit 12 and the storage unit 13.

As the electronic circuit, a single circuit, a composite circuit, a programmed processor, a parallel-programmed processor, a logic IC, a GA, an ASIC or an FPGA is supposed. GA is an abbreviation for Gate Array. ASIC is an abbreviation for Application Specific Integrated Circuit. FPGA is an abbreviation for Field-Programmable Gate Array.

Each functional component may be realized by one electronic circuit, or may be realized by a plurality of electronic circuits dispersedly.

### Second Variation

As Second Variation, a part of each functional component may be realized by a hardware component, and the other part of each functional component may be realized by software.

The processor 11, the memory unit 12, the storage unit 13 and the electronic circuit are called processing circuitry. That is, the functions of each functional component are realized by processing circuitry.

Further, “unit” in the description above may be replaced with “circuit”, “step”, “procedure”, “process” or “processing circuitry”.

In the above, description has been made on the embodiment and the variations of the present disclosure. Some of these embodiment and variations may be combined and performed. Otherwise, any or some may be partially performed. The present disclosure is not limited to the embodiment and the variations described above, and various modifications can be added as needed.

### REFERENCE SIGNS LIST

10: asset management device; 11: processor; 12: memory unit; 13: storage unit; 14: communication interface; 15: input and output interface; 21: setting acceptance unit; 22: calculation unit; 23: visualization unit; 24: business value calculation unit; 25: asset value calculation unit; 26: contribution degree calculation unit; 31: interested person storage unit; 32: asset information storage unit; 33: relation information storage unit; 80: signal line; 81: external system; 90: network; 91: client terminal

1. An asset management device comprising:
processing circuitry
to calculate an asset value with respect to an asset being an evaluation target based on an evaluation axis in a target business process, the evaluation axis being for evaluating the asset value, while using each of a plurality of business processes as a target, and
to calculate an asset contribution degree indicating a degree that the asset being the evaluation target contributes to an organization objective by synthesizing the asset value calculated with respect to one or more business processes to realize a business strategy which is set to achieve the organization objective.

2. The asset management device as defined in claim 1, wherein
a ratio is set for each of the one or more business processes, and
the processing circuitry synthesizes the asset value and calculates the asset contribution degree by calculating a value obtained by multiplying the asset value by the ratio with respect to each of the one or more business processes, and by totaling the value calculated.

3. The asset management device as defined in claim 1, wherein
one or more business strategies are set to achieve the organization objective,
an achievement goal to achieve the organization objective is set for each of the one or more business strategies,
the processing circuitry calculates a business value being a value of a target business strategy, from a coefficient obtained from a proportion of a desired value indicated in the achievement goal set for the target business strategy relative to a desired value indicated in the organization objective, and a proportion of a realized value achieved with the target business strategy relative to the desired value indicated in the achievement goal set for the target business strategy, while using each of the one or more business strategies as a target,
and the processing circuitry calculates the asset contribution degree from the business value with respect to the target business strategy calculated, and a value obtained by synthesizing the asset value calculated with respect to one or more business processes to realize the target business strategy.

4. The asset management device as defined in claim 2, wherein
one or more business strategies are set to achieve the organization objective,
an achievement goal to achieve the organization objective is set for each of the one or more business strategies,
the processing circuitry calculates a business value being a value of a target business strategy, from a coefficient obtained from a proportion of a desired value indicated in the achievement goal set for the target business strategy relative to a desired value indicated in the organization objective, and a proportion of a realized value achieved with the target business strategy relative to the desired value indicated in the achievement goal set for the target business strategy, while using each of the one or more business strategies as a target,
and the processing circuitry calculates the asset contribution degree from the business value with respect to the target business strategy calculated, and a value obtained by synthesizing the asset value calculated with respect to one or more business processes to realize the target business strategy.

5. The asset management device as defined in claim 1, wherein the processing circuitry displays the asset value with respect to the asset being the evaluation target, and the asset contribution degree with respect to the asset being the evaluation target to the organization objective calculated.

6. The asset management device as defined in claim 2, wherein the processing circuitry displays the asset value with respect to the asset being the evaluation target, and the asset contribution degree with respect to the asset being the evaluation target to the organization objective calculated.

7. The asset management device as defined in claim 3, wherein the processing circuitry displays the asset value with respect to the asset being the evaluation target, and the asset contribution degree with respect to the asset being the evaluation target to the organization objective calculated.

8. The asset management device as defined in claim 4, wherein the processing circuitry displays the asset value with respect to the asset being the evaluation target, and the asset contribution degree with respect to the asset being the evaluation target to the organization objective calculated.

9. The asset management device as defined in claim 1, wherein the processing circuitry accepts setting of the evaluation axis.

10. The asset management device as defined in claim 2, wherein the processing circuitry accepts setting of the evaluation axis.

11. The asset management device as defined in claim 3, wherein the processing circuitry accepts setting of the evaluation axis.

12. The asset management device as defined in claim 4, wherein the processing circuitry accepts setting of the evaluation axis.

13. The asset management device as defined in claim 5, wherein the processing circuitry accepts setting of the evaluation axis.

14. The asset management device as defined in claim 6, wherein the processing circuitry accepts setting of the evaluation axis.

15. The asset management device as defined in claim 7, wherein the processing circuitry accepts setting of the evaluation axis.

16. The asset management device as defined in claim 8, wherein the processing circuitry accepts setting of the evaluation axis.

17. An asset management method comprising:
by a computer, calculating an asset value with respect to an asset being an evaluation target based on an evaluation axis in a target business process, the evaluation axis being for evaluating the asset value, while using each of a plurality of business processes as a target, and
by the computer, calculating an asset contribution degree indicating a degree that the asset being the evaluation target contributes to an organization objective by synthesizing the asset value calculated with respect to one or more business processes to realize a business strategy which is set to achieve the organization objective.

18. A non-transitory computer readable medium storing an asset management program to cause a computer to function as an asset management device performing:
an asset value calculation process to calculate an asset value with respect to an asset being an evaluation target based on an evaluation axis in a target business process, the evaluation axis being for evaluating the asset value, while using each of a plurality of business processes as a target, and
a contribution degree calculation process to calculate an asset contribution degree indicating a degree that the asset being the evaluation target contributes to an organization objective by synthesizing the asset value calculated by the asset value calculation process with respect to one or more business processes to realize a business strategy which is set to achieve the organization objective.
